(19) United States
(12) Patent Application Publication
(10) Pub. No.: US 2025/0252111 A1
(43) Pub. Date: Aug. 7, 2025

(54) TECHNIQUES FOR PROVIDING RELEVANT SEARCH RESULTS FOR SEARCH QUERIES

(71) Applicant: Apple Inc., Cupertino, CA (US)

(72) Inventors: Vishalaksh AGGARWAL, Seattle, WA (US); Santosh SHANKAR, Santa Clara, CA (US); Kushal Subhash TAYAL, Santa Clara, CA (US); Nicholas A. TUCEY, Los Gatos, CA (US); Ramana M. IDURY, Elk Grove, CA (US); Sean SUCHTER, Los Altos Hills, CA (US); Suriyanarayanan VENKATESAN, Singapore (SG); Jagannadan VARADARAJAN, Singapore (SG)

(21) Appl. No.: 19/038,072

(22) Filed: Jan. 27, 2025

Related U.S. Application Data
(60) Provisional application No. 63/551,033, filed on Feb. 7, 2024.

(51) Int. Cl. G06F 16/2457; G06F 16/248

(52) U.S. Cl. CPC G06F 16/24578; G06F 16/248

(57) ABSTRACT

A technique that includes the steps of (1) generating a query vector based at least in part on a query received from a user account that is associated with a user account vector, (2) combining the query vector and the user account vector to establish a combined vector, (3) generating an output vector based at least in part on the combined vector, (4) obtaining, based on the query, a plurality of item vectors, where each item vector of the plurality of item vectors corresponds to a respective item, (5) comparing the output vector to the plurality of item vectors to generate respective similarity scores, (6) ordering the plurality of item vectors in accordance with the similarity scores to establish an ordered plurality of item vectors, and (7) causing the client computing device to display respective affordances for the items that correspond to the ordered plurality of item vectors.

### CROSS-REFERENCE TO RELATED APPLICATIONS

The present application claims priority to U.S. Provisional Patent Application Ser. No. 63/551,033, entitled “TECHNIQUES FOR PROVIDING RELEVANT SEARCH RESULTS FOR SEARCH QUERIES,” filed Feb. 7, 2024, which is hereby incorporated by reference in its entirety for all purposes.

### FIELD

The described embodiments relate generally to implementing search algorithms. More particularly, the described embodiments provide techniques for providing relevant search results for search queries.

### BACKGROUND

Returning relevant search results to users based on their search queries can be a complex endeavor. In particular, returning relevant search results requires a sophisticated understanding of users' intent as well as efficiently accessing and utilizing the vast amount of information that is available (e.g., through local databases, knowledge graphs, the Internet, etc.). This can be difficult, however, for at least the following reasons.

First, the inherent ambiguity in search queries presents a significant challenge. In particular, users often express their informational needs in imprecise or vague terms, which can make it difficult for search engines to accurately interpret the users' intent. For example, a user searching for “java” could be looking for information about the island of Java in Indonesia, Java coffee, or the programming language Java®. Despite these challenges, deciphering users' intent remains an important aspect in providing relevant search results to them.

Second, the sheer volume of data that is accessible to search engines-such as through the Internet, through locally-accessible data sets, etc.—can be overwhelming. For example, search engines must crawl and index an immense number of web pages, and this vastness of information makes it challenging to ensure that all relevant data is considered when providing search results. Additionally, it is resource-intensive to keep these indexes up to date relative to the constantly-changing landscape of the Internet.

Third, language and cultural nuances often can add another layer of complexity. In particular, search engines must consider regional language variations, idiomatic expressions, and cultural differences to provide search results to users that are relevant and contextual to their locales. This can be problematic, however, as the meaning of a commonly used search term in one region could be entirely different in another, thereby leading to potential misinterpretations and inaccurate/irrelevant search results.

Additionally, personalization plays a crucial role in providing search results, but it also introduces challenges. In particular, a given search engine may aim to provide results that are tailored to a given user's individual preferences, search history, and so on. However, striking the right balance between personalization, diversity, and privacy considerations can be difficult. For example, a search engine that overemphasizes the user's search history may generate results that are highly specific to the user even when the user is only seeking a generic response to their inquiry. Conversely, a search engine that disregards the user's search history may generate search results that are highly generic to the user despite the user's desire to obtain more personalized search results.

In sum, the difficulty of returning relevant search results to users based on their search inputs arises from the ambiguity of search queries, the vastness of available information, language and cultural nuances, the complexities of personalization (while respecting privacy), and the ever-evolving nature of search engine algorithms. Addressing these challenges requires a combination of advanced technology, ongoing research, and a deep understanding of user behavior and intent in order to continually improve search experiences for users.

Accordingly, what is needed are improved techniques for providing relevant search results to users in response to their search queries.

### SUMMARY

The described embodiments relate generally to implementing search algorithms. More particularly, the described embodiments provide techniques for providing relevant search results for search queries.

One embodiment sets forth a method for providing relevant search results for search queries. According to some embodiments, the method can be implemented by a server computing device, and includes the steps of (1) generating a query vector based at least in part on a query received from a client computing device, where the client computing device is associated with a user account, and the user account is associated with a user account vector, (2) combining the query vector and the user account vector to establish a combined vector, (3) generating an output vector based at least in part on the combined vector, (4) obtaining, based at least in part on the query, a plurality of item vectors, where each item vector of the plurality of item vectors corresponds to a respective item, (5) comparing the output vector to the plurality of item vectors to generate respective similarity scores, (6) ordering the plurality of item vectors in accordance with the similarity scores to establish an ordered plurality of item vectors, and (7) causing the client computing device to display, in accordance with the ordered plurality of item vectors, respective affordances for the items that correspond to the ordered plurality of item vectors.

According to some embodiments, the query comprises text content, image content, audio content, video content, or some combination thereof. According to some embodiments, the query vector is generated based at least in part on the query using a transformer-based large language model (LLM). According to some embodiments, the user account vector is generated based at least in part on: (i) a first set item vectors that correspond to Decisions marked as favorites under the user account; (ii) a second set of item vectors that correspond to Decisions included in a library of Decisions associated with the user account; (iii) a third set of item vectors that correspond to Decisions accessed by the user account within a first threshold period of time; and (iv) a fourth set of query vectors that correspond to queries provided in association with the user account within a second threshold period of time.

According to some embodiments, combining the query vector and the user account vector to establish the combined vector comprises concatenating the query vector to the user account vector, or vice-versa. According to some embodiments, the output vector is generated based at least in part on the combined vector using a transformer-based large language model (LLM), and the transformer-based LLM implements a set of fully connected layers and a set of input normalization layers.

According to some embodiments, a given item vector of the plurality of item vectors is generated by (i) obtaining, from a transformer-based LLM, a first item vector based at least in part on metadata associated with the corresponding respective item, (ii) obtaining, from a machine learning model, a second item vector based at least in part on data content of the corresponding respective item, and (iii) generating the item vector based at least in part on combining the first and second item vectors.

According to some embodiments, when the corresponding respective item comprises an audio file, the metadata comprises the following song properties: album, artist, title, track number, genre, year, duration, bitrate, sample rate, channels, composer, comment, copyright, encoder, language, publisher, original artist, album artist, disc number, lyrics, mood, tempo, key, ISRC (International Standard Recording Code), recording date, release date, label, BPM (beats per minute), performer, conductor, compilation, part of a set, podcast, podcast URL, podcast ID, podcast feed, episode number, episode ID, episode URL, cover art, custom tags, or some combination thereof; and the data content comprises the following song characteristics: melody, harmony, rhythm, tempo, meter, lyrics, chorus, verse, bridge, dynamics, instrumentation, arrangement, key, harmonic progression, timbre, form, texture, style, emotion, production, hook, groove, transition, or some combination thereof.

Other embodiments include a non-transitory computer readable storage medium configured to store instructions that, when executed by a processor included in a computing device, cause the computing device to carry out the various steps of any of the foregoing methods. Further embodiments include a computing device that is configured to carry out the various steps of any of the foregoing methods.

Other aspects and advantages of the embodiments described herein will become apparent from the following detailed description taken in conjunction with the accompanying drawings which illustrate, by way of example, the principles of the described embodiments.

### BRIEF DESCRIPTION OF THE DRAWINGS

The included drawings are for illustrative purposes and serve only to provide examples of possible structures and arrangements for the disclosed inventive apparatuses and methods for providing wireless computing devices. These drawings in no way limit any changes in form and detail that may be made to the embodiments by one skilled in the art without departing from the spirit and scope of the embodiments. The embodiments will be readily understood by the following detailed description in conjunction with the accompanying drawings, wherein like reference numerals designate like structural elements.

FIG. 1 illustrates a block diagram of different components of a system that can be configured to implement the various techniques described herein, according to some embodiments.

FIG. 2 illustrates a block diagram that provides an understanding of how a user/query manager, a song manager, a similarity analyzer, and a personalized ranking engine can function, interact with one another, etc., to generate query results for search queries, according to some embodiments.

FIG. 3 illustrates a block diagram that provides examples of different aspects, characteristics, etc., of a user account that can be considered when generating a corresponding user account vector, according to some embodiments.

FIG. 4 illustrates a block diagram that provides an example approach for generating a query vector based on a search query, according to some embodiments.

FIG. 5 illustrates a block diagram that provides examples of different aspects, characteristics, etc., of a song that can be considered when generating a corresponding song metadata vector and a corresponding song audio vector, according to some embodiments.

FIG. 6 illustrates a block diagram of how personalized query results can be generated for a given search query, according to some embodiments.

FIG. 7 illustrates a block diagram of how semantic query results can be generated for a given search query, according to some embodiments.

FIG. 8 illustrates a method for providing relevant search results for search queries, according to some embodiments.

FIG. 9A illustrates a detailed view of a computing device that can be used to implement the various components described herein, according to some embodiments.

FIGS. 9B-9G illustrate the use of Application Programming Interfaces (APIs) to perform operations in accordance with some embodiments.

### DETAILED DESCRIPTION

Representative applications of apparatuses and methods according to the presently described embodiments are provided in this section. These examples are being provided solely to add context and aid in the understanding of the described embodiments. It will thus be apparent to one skilled in the art that the presently described embodiments can be practiced without some or all of these specific details. In other instances, well known process steps have not been described in detail in order to avoid unnecessarily obscuring the presently described embodiments. Other applications are possible, such that the following examples should not be taken as limiting.

The described embodiments relate generally to implementing search algorithms. More particularly, the described embodiments provide techniques for providing relevant search results for search queries.

Music streaming platforms, such as Apple Music®, intake a substantial number of songs to manage on a daily basis. This presents challenges with respect to providing relevant search results (i.e., songs) for search queries provided by users. In particular, the challenges include identifying songs that exhibit semantic relevance, but that are not necessarily an exact match to search queries. The challenges also include providing personalized (i.e., user-relevant) search results for different users who submit the same search query.

Accordingly, the embodiments set forth techniques for generating foundational song embeddings (also referred to herein as “vectors”). According to some embodiments, the techniques utilize features of a given song that are available at the time of intake to train models and to subsequently have a corresponding song embedding readily available relative to its release. According to some embodiments, stable input embeddings can be utilized so that the song embeddings can be generated and utilized without having to retrain the models at frequent intervals. According to some embodiments, a given song embedding can stem from multiple modalities of its corresponding song, such as text features (e.g., song metadata), image features (e.g., album art), video features (e.g., song videos), audio (e.g., song content), and so on.

As described in greater detail herein, the aforementioned modalities can be utilized to enrich contextual comprehension and to adeptly manage instances of ambiguity (e.g., where the song's metadata falls short in enabling disambiguation). Moreover, because the embodiments described herein leverage content-based features that are available at the time of the release of a given song, relevant songs can be identified somewhat immediately (in contrast to leveraging behavioral-focused features, which are only available after sufficient information is collected with respect to how users interact with the song). As a result, various benefits can be achieved, which are discussed in greater detail herein.

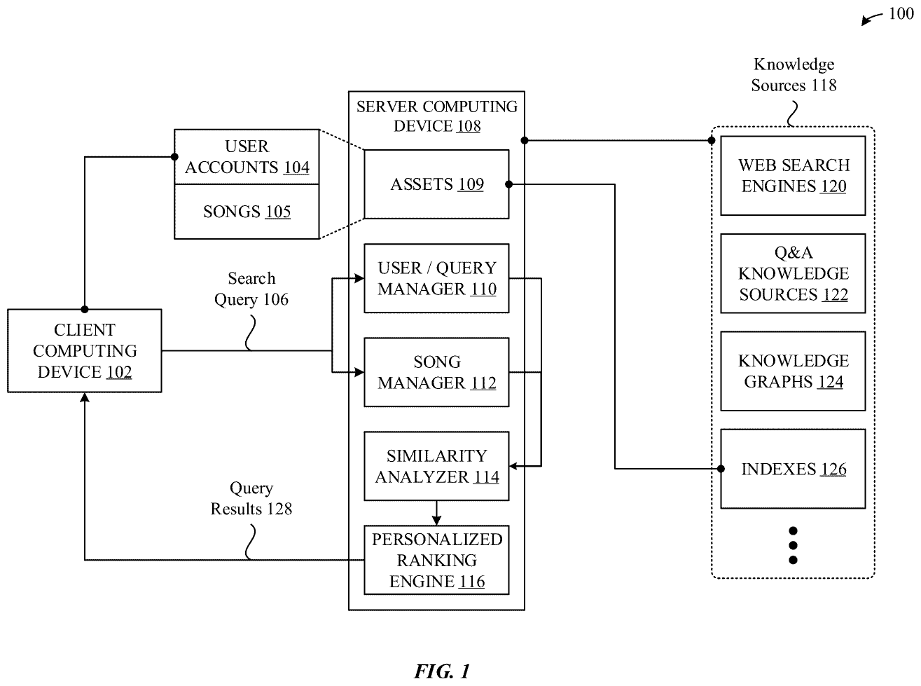

FIG. 1 illustrates a block diagram of different components of a system 100 that can be configured to implement the various techniques described herein, according to some embodiments. As shown in FIG. 1, the system 100 can include a client computing device 102 and a server computing device 108. It is noted that, in the interest of simplifying this disclosure, the client computing device 102 and the server computing device 108 are typically discussed in singular capacities. In that regard, it should be appreciated that the system 100 can include any number of client computing devices 102 and server computing devices 108, without departing from the scope of this disclosure.

According to some embodiments, the client computing device 102 and the server computing device 108 can represent any form of computing device operated by an individual, an entity, etc., such as a wearable computing device, a smartphone computing device, a tablet computing device, a laptop computing device, a desktop computing device, a gaming computing device, a smart home computing device, an Internet of Things (IoT) computing device, a rack mount computing device, and so on. It is noted that the foregoing examples are not meant to be limiting, and that the client computing device 102/server computing device 108 can represent any type, form, etc., of computing device, without departing from the scope of this disclosure.

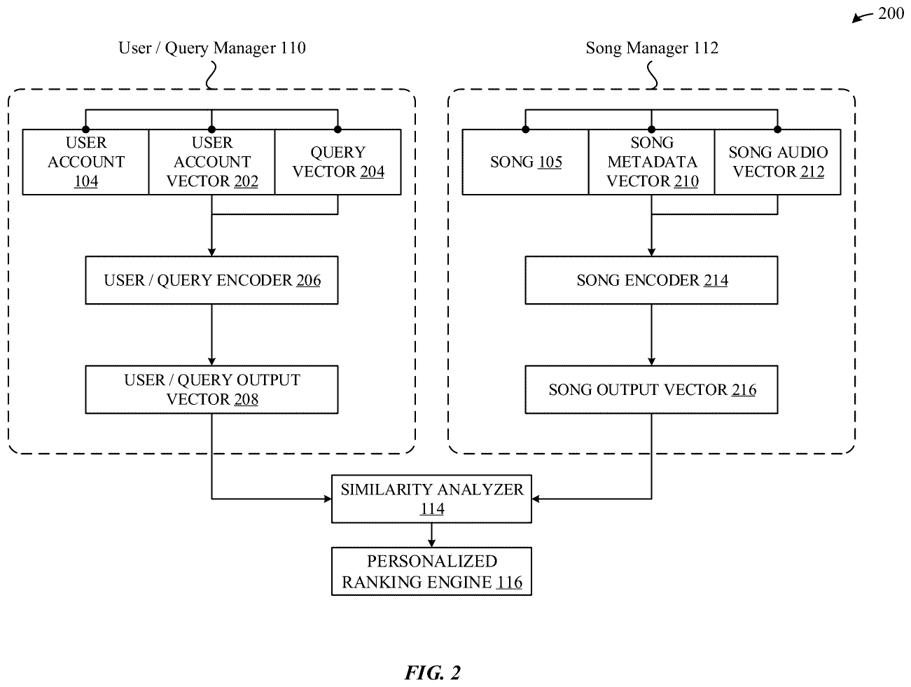

As shown in FIG. 1, the client computing device 102 can be associated with (i.e., logged into) a user account 104 that is known to the server computing device 108. The server computing device 108 can manage assets 109 (e.g., stored on one or more local storage devices, one or more network storage devices, one or more cloud-based storages, etc.), which includes the user accounts 104 and information associated therewith. For example, the user account 104 can be associated with username/password information, demographic-related information, device-related information (e.g., identifiers of client computing devices 102 associated with the user account 104), and the like. The user account 104 can also be associated with conversation history information, which can include information associated with search queries 106 (provided by the client computing device 102), query results 128 (returned to the client computing device 102), as well as any other type, form, etc., of information, at any level of granularity, pertaining to activity performed at the client computing device 102, activity performed at the server computing device 108, the interactions between the client computing device 102 and the server computing device 108, and so on. As described in greater detail herein, the user account 104 can also be associated with a user account vector (that is based at least in part on the user account 104), query vectors (that are based at least in part on search queries 106 provided by client computing devices 102 associated with the user account 104), and the like. A more detailed explanation of the user account 104 and its associated information is provided below in conjunction with FIGS. 2-4.

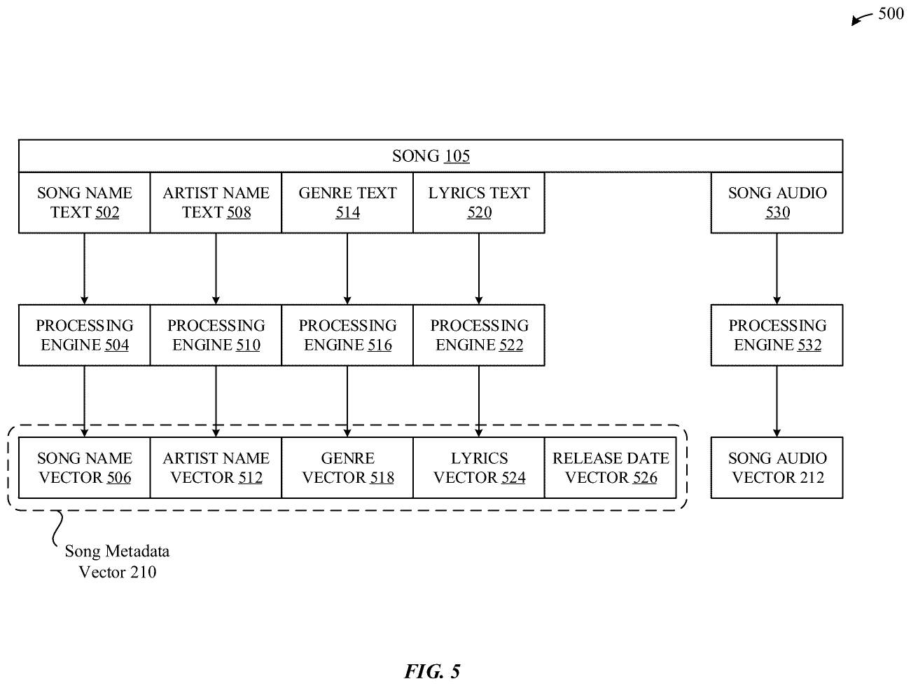

As shown in FIG. 1, the assets 109 can also include songs 105, where each song 105 can be associated with metadata content, audio content, and so on. As described in greater detail herein, each song 105 can be associated with additional information, such as a song metadata vector (that is based at least in part on metadata of the song 105), a song audio vector (that is based at least in part on audio content of the song 105), and the like. A more detailed explanation of the songs 105 and their associated information is provided below in conjunction with FIGS. 2 and 5.

As shown in FIG. 1, and as described in greater detail herein, the client computing device 102 can issue search queries 106 to the server computing device 108 (e.g., via the Internet, a network connection, etc.), where, in turn, the server computing device 108 can generate and provide query results 128 to the client computing device 102 (over the aforementioned connections, a different connection, etc.). According to some embodiments, the query results 128 can be organized, formatted, etc., in a manner that is understood by the client computing device 102. In turn, the client computing device 102 can display the query results 128 using the appropriate applications, user interfaces, etc., to enable a user of the client computing device 102 to interact with the query results 128.

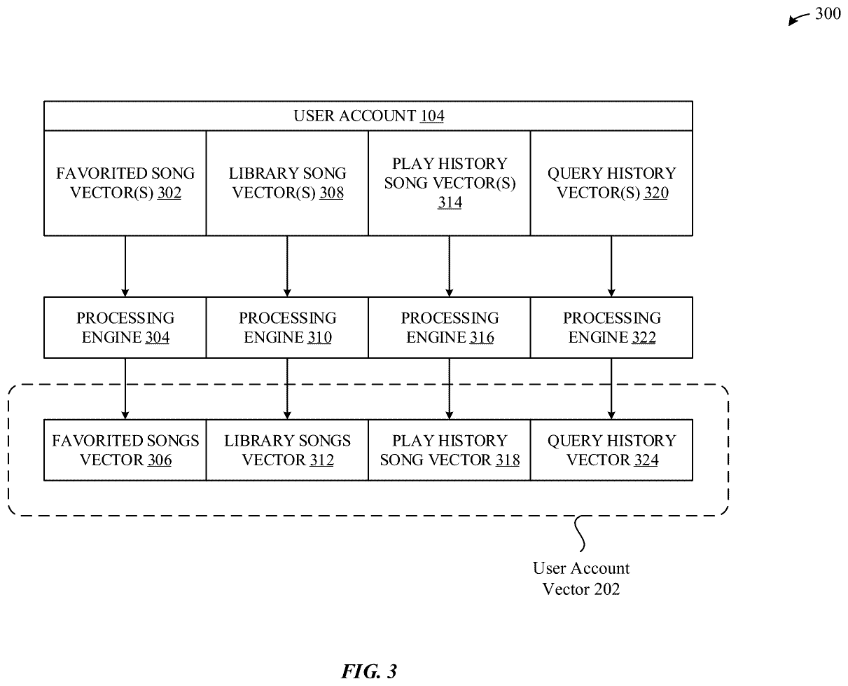

As described in greater detail herein, the user account 104 can be utilized to improve the overall accuracy of the query results 128 that are generated and provided by the server computing device 108 for search queries 106. According to some embodiments, the server computing device 108 can implement a user/query manager 110. As described below in conjunction with FIGS. 2-3, the user/query manager 110 can be configured to generate/maintain the aforementioned user account vectors for the user accounts 104, to generate query vectors for search queries 106 received from client computing devices 102 associated with the user accounts 104, and to perform other functionalities that are described herein. In turn, the user/query manager 110 can generate user/query output vectors that can be utilized, at least in part along with song output vectors (the details of which are described below), to provide query results 128 that are relevant to the search queries 106, personalized to the user accounts 104, and so on.

According to some embodiments, the server computing device 108 can implement a song manager 112. As described below in conjunction with FIGS. 2 and 5, the song manager 112 can be configured to generate/maintain the aforementioned song metadata vectors, song audio vectors, etc., for the songs 105. In doing so, the song manager 112 can generate song output vectors that can be utilized, at least in part along with the user/query output vectors, to provide query results 128 that are relevant to the search queries 106, personalized to the user accounts 104, and so on.

Additionally, and as shown in FIG. 1, the server computing device 108 can implement a similarity analyzer 114, which can be configured to compare the outputs from the user/query manager 110 and the song manager 112 (i.e., the user/query output vectors and the song output vectors, respectively). In particular, the similarity analyzer 114 can implement algorithms that compare the similarities between the aforementioned output vectors, generate scores that represent/coincide with the similarities, and so on. The algorithms can include, for example, Cosine Similarity, Euclidean Distance, Manhattan Distance (L1 norm), Jaccard Similarity, Hamming Distance, Pearson Correlation Coefficient, Spearman Rank Correlation, Minkowski Distance, Kullback-Leibler Divergence (KL Divergence), and so on. It is noted that the foregoing examples are not meant to be limiting, and that the similarity analyzer 114 can implement any number, type, form, etc., of similarity analysis algorithms, at any level of granularity, consistent with the scope of this disclosure.

According to some embodiments, the user/query manager 110, the song manager 112, and the similarity analyzer 114 can represent one or more artificial intelligence (AI) models-such as small language models (SLMs), large language models (LLMs), rule-based models, traditional machine learning models, custom models, ensemble models, knowledge graph models, hybrid models, domain-specific models, sparse models, transfer learning models, symbolic artificial intelligence (AI) models, generative adversarial network models, reinforcement learning models, biological models, and the like. It is noted that the foregoing examples are not meant to be limiting, and that any number, type, form, etc., of AI models, can be implemented by any of the entities illustrated in FIG. 1, without departing from the scope of this disclosure. It is also noted that the server computing device 108 can be configured to identify and eliminate “AI hallucinations,” which refer to the generation of false or distorted perceptions, ideas, or sensations by AI systems. This phenomenon can occur when AI models, such as LLMs, generate outputs that are not based on real data but instead originate from patterns or noise present in their training data or model architecture. Such hallucinations can manifest as incorrect information, fantastical scenarios, nonsensical sentences, or a blend of real and fabricated content. It is also noted that one or more of the entities illustrated in FIG. 1 can represent non-AI-based entities, such as rules-based systems, knowledge-based systems, and so on.

As additionally shown in FIG. 1, the server computing device 108 can implement a personalized ranking engine 116, which can be configured to provide query results 128 that are personalized for the user accounts 104 (based at least in part on, for example, the similarity analyses performed by the similarity analyzer 114). Personalizing query results 128 for a given search query 106 (e.g., provided by a client computing device 102 associated with a user account 104), can include, for example, culling songs 105 having similarity scores that do not satisfy a particular threshold (that coincides with the similarity score scheme), reordering the remaining songs 105 based on their similarity scores, emphasizing songs 105 having similarity scores that satisfy a particular threshold, and so on. It is noted that the foregoing examples are not meant to be limiting, and that the personalized ranking engine 116 can implement any number, type, form, etc., of operations to filter songs 105 to be included in query results 128, at any level of granularity, consistent with the scope of this disclosure.

Additionally, and according to some embodiments, the personalized ranking engine 116 can be configured to implement an explanation agent (not illustrated in FIG. 1). According to some embodiments, the explanation agent can be configured to implement any number, type, form, etc., of AI models to provide explanations for one or more of the query results 128. To implement this functionality, the explanation agent can analyze any information. In one example, the explanation for a given query result 128 can include a breakdown of why the query result 128 is relevant, a breakdown of how the query result 128 was identified, a breakdown of where the query result 128 was located, and so on. It is noted that the foregoing examples are not meant to be limiting, and that the explanations can include any amount, type, form, etc., of information, at any level of granularity, without departing from the scope of this disclosure.

Additionally, it is noted that, under some configurations, the explanation agent can also be configured to provide explanations for query results 128 that were filtered out by the personalized ranking engine 116. In turn, such explanations can be utilized in any manner to improve the manner in which the system 100 generates query results 128. For example, the explanations can be used to improve the intelligence of the various AI models discussed herein, to demonstrate to end-users that time is being saved by intelligently eliminating certain results for good/explainable reasons, and so on.

Additionally, and according to some embodiments, the personalized ranking engine 116 can be configured to implement a content agent (not illustrated in FIG. 1). According to some embodiments, the content agent can be configured to implement any number, type, form, etc., of AI models to generate content that is relevant to the query results 128. For example, the content agent can implement generative adversarial networks (GANs), variational autoencoders (VAEs), recurrent neural networks (RNNs), convolutional neural networks (CNNs), neuroevolution systems, deep dream systems, style transfer systems, rule-based systems, interactive evolutionary algorithms, and so on. Such content can include, for example, digital content that corresponds to the query results 128 (e.g., text content, image content, audio content, video content, etc.). It is noted that the foregoing examples are not meant to be limiting, and that the content agent can generate any amount, type, form, etc., of digital content, at any level of granularity, without departing from the scope of this disclosure. For example, the content can include audio content, video content, document content, web content (e.g., hypertext markup language (HTML) content), programming language content, and so on.

As further shown in FIG. 1, the server computing device 108—particularly, the various entities implemented thereon—can be configured to interface with knowledge sources 118. According to some embodiments, the knowledge sources 118 can include, for example, web search engines 120, question and answer (Q&A) knowledge sources 122, knowledge graphs 124, indexes 126 (e.g., databases, approximate nearest-neighbor (ANN) indexes, inverted indexes, etc.), and so on. It is noted that the knowledge sources 118 illustrated in FIG. 1 and described herein are not meant to be limiting, and that the entities implemented on the server computing device 108 can be configured to access any type, kind, form, etc., of knowledge source 118 that is capable of receiving queries and providing responses, without departing from the scope of this disclosure. It should also be understood that the knowledge sources 118 can employ any number, type, form, etc., of AI models (or non-AI based approaches) to provide the various functionalities described herein, without departing from the scope of this disclosure. It should also be understood that the knowledge sources 118 can be implemented by any computing entity (e.g., the client computing device 102, the server computing device 108, etc.), service (e.g., cloud services), etc., without departing from the scope of this disclosure.

According to some embodiments, the web search engines 120 can represent web search entities that are capable of receiving queries and providing answers based on what is accessible via the Internet. To implement this functionality, the web search engines 120 can “crawl” the Internet, which involves identifying, parsing, and indexing the content of web pages, such that relevant content can be efficiently identified for search queries that are received. According to some embodiments, the Q&A knowledge sources 122 can represent systems, databases, etc., that can formulate answers to questions that are commonly received. To implement this functionality, the Q&A knowledge sources 122 typically rely on structured or semi-structured knowledge bases that contain a wide range of information, facts, data, or textual content that is manually curated, generated from text corpora, or collected from various sources, such as books, articles, databases, or the Internet.

According to some embodiments, the knowledge graphs 124 can represent systems, databases, etc., that can be accessed to formulate answers to queries that are received. A given knowledge graph 124 typically constitutes a structured representation of knowledge that captures relationships and connections between entities, concepts, data points, etc. in a way that computing devices are capable of understanding. According to some embodiments, the indexes 126 can represent systems, databases, etc., that can be accessed to formulate answers to queries that are received. For example, the indexes 126 can include an ANN index that constitutes a data structure that is arranged in a manner that enables similarity searches and retrievals in high-dimensional spaces to be efficiently performed. This makes the ANN indexes particularly useful when performing tasks that involve semantic information retrieval, recommendations, and finding similar data points, objects, and so on.

It is noted that the logical breakdown of the entities illustrated in FIG. 1—as well as the logical flow of the manner in which such entities communicate-should not be construed as limiting. On the contrary, any of the entities illustrated in FIG. 1 can be separated into additional entities within the system 100, combined together within the system 100, or removed from the system 100, without departing from the scope of this disclosure. It is additionally noted that, in the interest of unifying and simplifying this disclosure, the described embodiments primarily pertain to song-related implementations. However, it should be appreciated that the embodiments disclosed herein can be implemented to receive search queries 106—and to provide query results 128—for any type of digital content, such as audio files, documents, photos, videos, spreadsheets, presentations, databases, archives, executables, scripts, web files, configuration files, logs, programming source code, system files, fonts, backups, disk images, CAD files, and so on. It is noted that the foregoing examples are not meant to be limiting, and that the embodiments can apply to any amount, type, form, etc., of digital content, at any level of granularity, consistent with the scope of this disclosure.

Additionally, it should be understood that the various components of the computing devices illustrated in FIG. 1 are presented at a high level in the interest of simplification. For example, although not illustrated in FIG. 1, it should be appreciated that the various computing devices can include common hardware/software components that enable the above-described software entities to be implemented. For example, each of the computing devices can include one or more processors that, in conjunction with one or more volatile memories (e.g., a dynamic random-access memory (DRAM)) and one or more storage devices (e.g., hard drives, solid-state drives (SSDs), etc.), enable the various software entities described herein to be executed. Moreover, each of the computing devices can include communications components that enable the computing devices to transmit information between one another.

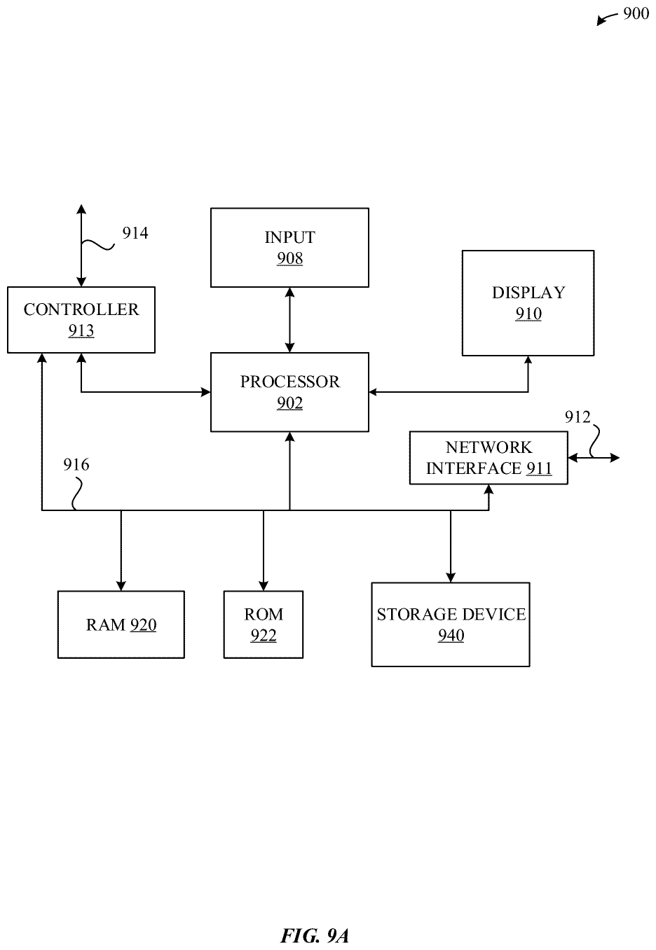

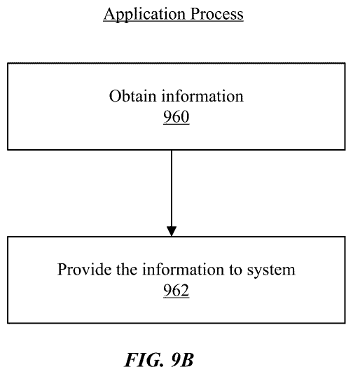

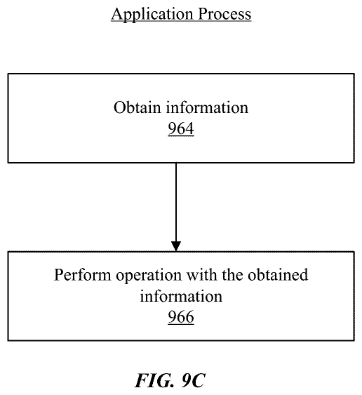

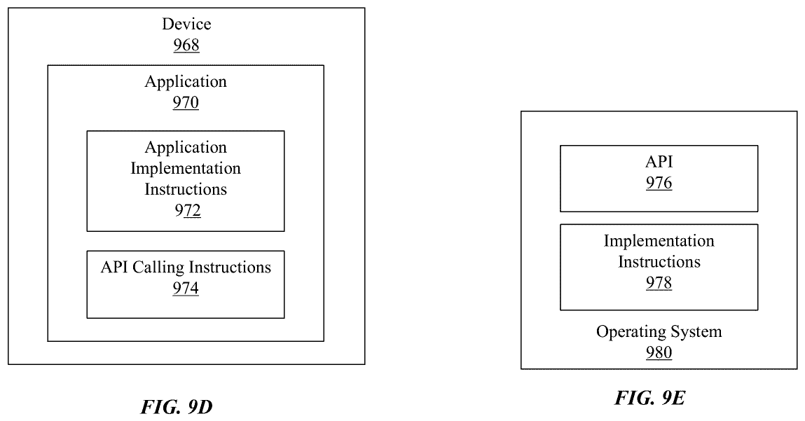

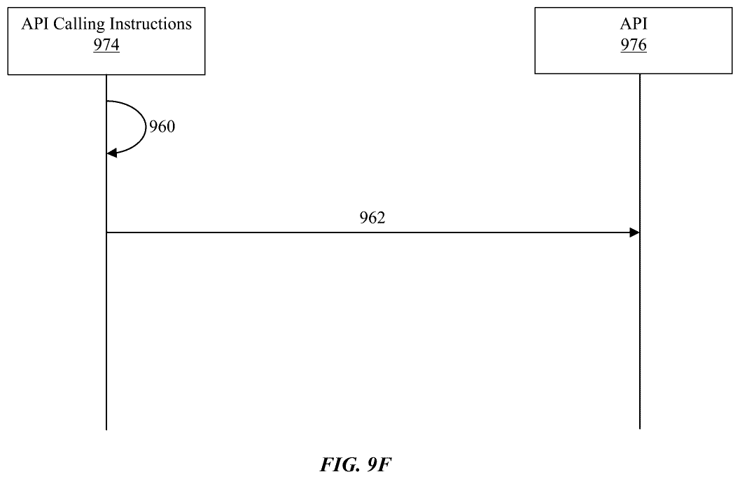

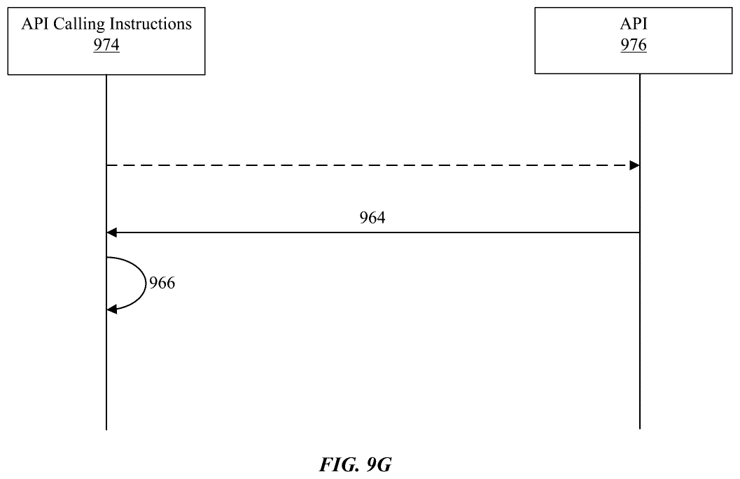

A more detailed explanation of these hardware components is provided below in conjunction with FIG. 9. It should additionally be understood that the computing devices can include other entities that enable the implementation of the various techniques described herein, without departing from the scope of this disclosure. It should additionally be understood that the entities described herein can be combined or split into additional entities, without departing from the scope of this disclosure. It should further be understood that the various entities described herein can be implemented using software-based or hardware-based approaches, without departing from the scope of this disclosure.

Accordingly, FIG. 1 provides an overview of the manner in which the system 100 can implement the various techniques described herein, according to some embodiments. A more detailed breakdown of the manner in which these techniques can be implemented will now be provided below in conjunction with FIGS. 2-9.

FIG. 2 illustrates a block diagram 200 that provides an understanding of how the user/query manager 110, the song manager 112, the similarity analyzer 114, and the personalized ranking engine 116 can function, interact with one another, etc., to generate query results 128 for search queries 106, according to some embodiments. As shown in FIG. 2, the user/query manager 110 can manage, for each user account 104 that is known to the system 100, a respective user account vector 202. According to some embodiments, the user/query manager 110 can generate the user account vector 202 at an appropriate time, e.g., when the user account 104 is created, when the user account 104 is registered to access the song-related services provided by the server computing device 108, and so on. According to some embodiments, the user/query manager 110 can manage, update, etc., the user account vector 202 over time to account for new information that is provided in association with the user account 104, learned about the user account 104, and so on.

According to some embodiments, the vectors described herein can represent foundational embeddings (i.e., vectors) that are stable in nature. As a brief aside, in the realm of artificial intelligence (AI) and machine learning, the generation of stable vectors for data can utilized to implement effective model training and inference. Generating stable vectors involves a systematic approach that can begin with data preprocessing, where raw data undergoes cleaning procedures to address missing values, outliers, and inconsistencies. Numerical features can be standardized or normalized to establish a uniform scale, while categorical variables can be encoded into numerical representations through techniques such as one-hot encoding or label encoding. Feature engineering can be employed to identify and create relevant features that enhance the model's capacity to discern patterns within the data. Additionally, for text data, tokenization can be employed to break down the text into constituent words or sub-word units, which can then be converted into numerical vectors using methodologies like word embeddings.

The aforementioned vectorization process can be used to amalgamate all features into a unified vector representation. Careful consideration given to normalization to ensure stability across different feature scales. Additional considerations can involve the handling of sequential data through techniques such as recurrent neural networks (RNNs) and transformers, as well as dimensionality reduction methods such as Principal Component Analysis (PCA) or t-distributed Stochastic Neighbor Embedding (t-SNE). Embedding layers may also be applied for certain data types, and consistency throughout the vector generation process can be maintained to uphold stability in both training and inference phases. Moreover, thorough testing and validation on a separate dataset can help confirm that the generated vectors effectively encapsulate pertinent information and patterns within the data. This comprehensive approach can help ensure the reliability and stability of any AI system's overall performance, accuracy, and the like.

Additionally, it is noted that the various models described herein-such as the user/query manager 110 and the song manager 112—can undergo training using query-item pairs. In particular, positive samples can be derived from search logs, while negative samples can be randomly selected from both the library of songs and the logs. Moreover, incorporating log-based negative sampling can help prevent the models from favoring popular results consistently, as such results are prone to occur more frequently in the training data. In this regard, the embodiments effectively exercise contrastive learning, which can obviate the necessity for a balanced distribution of positive and negative samples.

It is noted that the foregoing description of AI-based approaches is not meant to be limiting, and that any number, type, form, etc., of AI-based (and/or non-AI-based) approaches can be utilized, at any level of granularity, to implement the features described herein, consistent with the scope of this disclosure.

Returning now to FIG. 2—and, in accordance with the foregoing description of foundational embeddings, vectors, AI models, and so on—the user account vector 202 constitutes a mathematical representation of various aspects, characteristics, etc., of the user account 104. The block diagram 300 of FIG. 3 provides examples of different aspects, characteristics, etc., of the user account 104 that can be considered when generating the user account vector 202, according to some embodiments. In particular, the user account vector 202 can be based at least in part on songs 105 that have been favorited, liked, etc., in association with the user account 104 (illustrated in FIG. 3 as favorited song vectors 302), songs 105 that are included in a library associated with the user account 104 (illustrated in FIG. 3 as library song vectors 308), and songs 105 that have been played back in association with the user account 104 (e.g., within a threshold period of time). As described in greater detail below, the user account vector 202 can also be based on a history of search requests for songs 105 received in association with the user account 104. It is noted that the informational elements illustrated in FIG. 3, and on which the user account vector 202 is based, are not meant to be limiting, and that any amount, type, form, etc., of information associated with the user account 104, at any level of granularity, can be utilized when forming the user account vector 202.

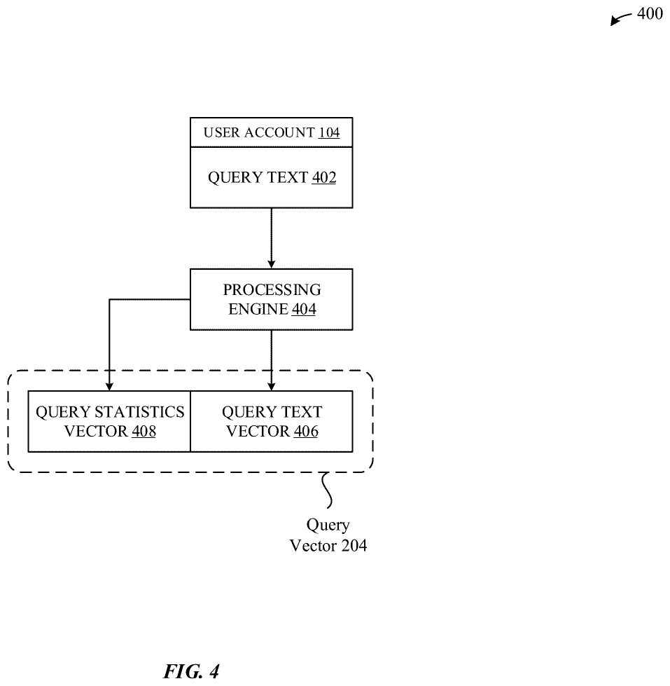

As described below in conjunction with FIG. 5, vector forms of the aforementioned songs 105 can be generated by the song manager 112, and the vector forms can be provided to processing engines 304, 310, and 316. Similarly, a vector form of the historical search queries received in association with the user account 104—which can be generated in accordance with the techniques described below in conjunction with FIG. 4—can be provided to a processing engine 322. According to some embodiments, each of the processing engine 304, 310, 316, and 322 can implement any amount, type, form, etc. of operations, at any level of granularity, to effectively pool, into a single vector, the respective collection of vectors that the processing engine receives.

As a brief aside, it is noted that in the domain of foundational embeddings, the amalgamation of information from multiple vectors into a singular representative vector can be performed using various pooling techniques. Among these methods, average pooling constitutes a straightforward yet effective approach, given it effectively captures central tendencies by computing the mean of vector values. In contrast, max pooling can highlight dominant features by selecting the maximum value from each dimension, while min pooling can accentuate less-extreme aspects by extracting the minimum value. Sum pooling can offer insight into overall magnitude by evaluating the total sum of vector values. Weighted pooling can introduce a nuanced perspective by assigning distinct weights to vector elements, thereby enabling a more tailored representation. The introduction of Lp-norm pooling generalizes the process by introducing a parameter P for flexibility in capturing different vector aspects. Attention pooling, with its dynamic weight assignment based on relevance through attention mechanisms, can add an adaptive layer to the context of the data.

It is noted that the foregoing pooling examples are not meant to be limiting. It is additionally noted that one or more of the processing engines 304, 310, 316, or 322 can implement transformer encoder networks that leverage any number, type, form, etc., of attention mechanisms to focus on specific parts of the vectors to reduce noise and to capture more pertinent information.

As shown in FIG. 3, the processing engine 304 generates a favorited songs vector 306 that is based at least in part on the one or more favorited song vectors 302. Similarly, the processing engine 310 generates a library songs vector 312 that is based at least in part on the one or more library song vectors 308. Similarly, the processing engine 316 generates a play history song vector 318 that is based at least in part on the one or more play history song vectors 314. Finally, the processing engine 322 generates a query history vector 324 that is based at least in part on the one or more query history vectors 320. According to some embodiments, the favorited songs vector 306, the library songs vector 312, the play history songs vector 318, and the query history vector 324 can be combined to form the user account vector 202 for the user account 104. For example, the favorited songs vector 306, library songs vector 312, play history songs vector 318, and query history vector 324 can be concatenated (e.g., in the order illustrated in FIG. 3, or in any other order) to form the user account vector 202.

Accordingly, FIG. 3 illustrates an example approach for establishing, maintaining, etc., a user account vector 202 that corresponds to a user account 104. It should be understood that the approaches illustrated in FIG. 3 are not meant to be limiting in any way, and that other, additional, etc., aspects, characteristics, etc., of/associated with the user account 104 (and/or other information) can be utilized to form the user account vector 202, consistent with the scope of this disclosure.

Returning now to FIG. 2, the user/query manager 110 can also manage query vectors 204 for search queries received in association with the user account 104. The block diagram 400 of FIG. 4 provides an example approach for generating a query vector 204 based on a search query, according to some embodiments. As shown in FIG. 4, query text 402 can be received in association with the user account 104 (e.g., via a search query 106 provided by a client computing device 102 with which the user account 104). According to some embodiments, a processing engine 404—e.g., one or more transformer-based large language models (LLMs)—can be utilized to generate a query text vector 406. The processing engine 404 can also be utilized to generate a query statistics vector 408 that complements the query text vector 406. For example, the query statistics vector 408 can be based on statistical attributes that correspond to the query text 402, such as a normalized frequency, conversion rates of the search query across distinct time windows, and so on. For example, the normalized frequencies can include a weekly query frequency, a monthly query frequency, a yearly query frequency, and the conversion rates can include a weekly query conversion rate, a monthly query conversion rate, a yearly query conversion rate. It is noted that the foregoing examples are not meant to be limiting, and that the normalized frequencies and conversion rates can include any amount, type, form, etc., of normalized frequencies and conversion rates, at any level of granularity, consistent with the scope of this disclosure.

As shown in FIG. 4, the query text vector 406 and the query statistics vector 408 can be combined to form the query vector 204 for the query text 402. For example, the query text vector 406 and the query statistics vector 408 can be concatenated (e.g., in the order illustrated in FIG. 4, or in any other order) to form the query vector 204. Accordingly, FIG. 4 illustrates an example approach for establishing, maintaining, etc., a query vector 204 that corresponds to query text 402. It should be understood that the approaches illustrated in FIG. 4 are not meant to be limiting in any way, and that other, additional, etc., aspects, characteristics, etc., of/associated with the query text 402 (and/or other information) can be utilized to form the query vector 204, consistent with the scope of this disclosure.

Returning now to FIG. 2, the user/query manager 110 can implement a user/query encoder 206 that receives, as an input, (1) the user account vector 202, and (2) a query vector 204. The user/query encoder 206 can receive the aforementioned inputs, for example, each time a query vector 204 is received in association with the user account 104 (associated with the user account vector 202). In turn, the user/query encoder 206 can process the user account vector 202 and the query vector 204 to generate a user/query output vector 208. According to some embodiments, the user/query encoder 206 can combine (e.g., concatenate) the user account vector 202 and the query vector 204 to produce the user/query output vector 208. It is noted that the user/query encoder 206 can process the user account vector 202/query vector 204, at any level of granularity and using any number, type, form, etc., of operations, prior to/subsequent to combining the user account vector 202 and the query vector 204, consistent with the scope of this disclosure. As described in greater detail below, the user/query output vector 208 can be provided to the similarity analyzer 114 for additional processing.

Additionally, and as shown in FIG. 2, the song manager 112 can manage, for each song 105, a respective (1) song metadata vector 210, and (2) a respective song audio vector 212. According to some embodiments, the block diagram 500 of FIG. 5 provides examples of different aspects, characteristics, etc., of the song 105 that can be considered when generating the song metadata vector 210 and the song audio vector 212, according to some embodiments. In one example approach, the song metadata vector 210 can be based on the song name of the song 105 (illustrated in FIG. 5 as song name text 502), the artist associated with the song 105 (illustrated in FIG. 5 as artist name text 508), the genre of the song 105 (illustrated in FIG. 5 as genre text 514), and the lyrics of the song 105 (illustrated in FIG. 5 as lyrics text 520). Other properties of the song 105 can be considered when generating the song metadata vector 210, such as the album, artist, title, track number, genre, year, duration, bitrate, sample rate, channels, composer, comment, copyright, encoder, language, publisher, original artist, album artist, disc number, lyrics, mood, tempo, key, ISRC (International Standard Recording Code), recording date, release date, label, BPM (beats per minute), performer, conductor, compilation, part of a set, podcast, podcast URL, podcast ID, podcast feed, episode number, episode ID, episode URL, cover art, custom tags, and the like. It is noted that the foregoing examples are not meant to be limiting, and that any amount, type, form, etc., of property of/associated with the song 105 can be considered when generating the song metadata vector 210, consistent with the scope of this disclosure.

According to some embodiments, the song name text 502, artist name text 508, genre text 514, and lyrics text 520 can be provided to the processing engines 504, 510, 516, and 522, respectively, to generate a song name vector 506, an artist name vector 512, a genre vector 518, and a lyrics vector 524, respectively. According to some embodiments, the processing engines 504, 510, 516, and 522 can implement any number of approaches for effectively generating vectors based on the inputs they receive. In particular, the processing engines 504, 510, 516, and 522 can represent transformer-based LLMs that are specifically tuned to work with the types of inputs they receive. For example, the processing engines 504, 510, and 516 can implement the same or similar small-token LLMs given they receive similar text inputs (i.e., song name, song artist, song genre) that are relatively small. Similarly, the processing engine 522—which receives larger text inputs (i.e., song lyrics)—can implement a large-token LLM that is specifically designed to manage larger inputs, one or more pooling engines to pool segmented portions of the lyrics (e.g., that have been vectorized by one or more LLMs), and so on. In any case, the song name vector 506, the artist name vector 512, the genre vector 518, and lyrics vector 524 can be combined (e.g., concatenated) together to form the song metadata vector 210. In some cases, a release date vector 526 that corresponds to the release date of the song 105 can be incorporated into the song metadata vector 210.

Additionally, and as shown in FIG. 5, the song audio vector 212 can be based on audio data of the song 105 (illustrated in FIG. 5 as song audio 530). According to some embodiments, the song audio 530 can be preprocessed prior to being provided to the processing engine 532. According to some embodiments, the song audio 530 can be provided to the processing engine 532, which can implement any number of approaches for generating the song audio vector 212 based on the song audio 530. For example, the processing engine 532 can implement a machine learning model-such as an audio encoding model—that generates the song audio vector 212 based on the song audio 530. The audio encoding model can be configured to focus on, for example, the melody, harmony, rhythm, tempo, meter, lyrics, chorus, verse, bridge, dynamics, instrumentation, arrangement, key, harmonic progression, timbre, form, texture, style, emotion, production, hook, groove, transition, of the song 105. It is noted that the foregoing examples are not meant to be limiting, and that the song audio vector 212 can be based on any amount, type, form, etc., of characteristics of the song 105/song audio 530, at any level of granularity, consistent with the scope of this disclosure.

Accordingly, FIG. 5 illustrates an example approach for establishing, maintaining, etc., a song metadata vector 210 and a song audio vector 212 that corresponds to a song 105. It should be understood that the approaches illustrated in FIG. 5 are not meant to be limiting in any way, and that other, additional, etc., aspects, characteristics, etc., of/associated with the song 105 (and/or other information) can be utilized to form the song metadata vector 210/song audio vector 212, consistent with the scope of this disclosure.

Returning now to FIG. 2, the song manager 112 can implement a song encoder 214 that receives, as an input for a given song 105, (1) a song metadata vector 210, and (2) a song audio vector 212. The song manager 112 can receive the aforementioned inputs, for example, each time a song 105 is received by the system 100 to be managed. In turn, the song encoder 214 can process the song metadata vector 210 and the song audio vector 212 to generate a song output vector 216. According to some embodiments, the song encoder 214 can combine (e.g., concatenate) the song metadata vector 210 and the song audio vector 212 to generate the song output vector 216. It is noted that the song encoder 214 can process the song metadata vector 210/song audio vector 212, at any level of granularity, using any number, type, form, etc., of operations, prior to/subsequent to combining the song metadata vector 210 and the song audio vector 212, consistent with the scope of this disclosure. As described in greater detail below, the song output vector 216 can be provided to the similarity analyzer 114 for additional processing.

Accordingly, as described in conjunction with FIG. 2, the similarity analyzer 114 can receive (1) a user/query output vector 208, and (2) one or more song output vectors 216, with the task of generating respective scores that represent an overall similarity between the user/query output vector 208 and the song output vectors 216. In turn, the personalized ranking engine 116 can be configured to receive the song output vectors 216, and to filter, order, etc., the song output vectors 216 based at least in part on their respective similarity scores. The songs 105 that correspond to the filtered, ordered, etc., song output vectors 216 can then be provided (e.g., to a client computing device 102 associated with the user account 104 that issued the search query 106) in the form of query results 128. In turn, a user can interact with the query results 128 by way of the client computing device 102.

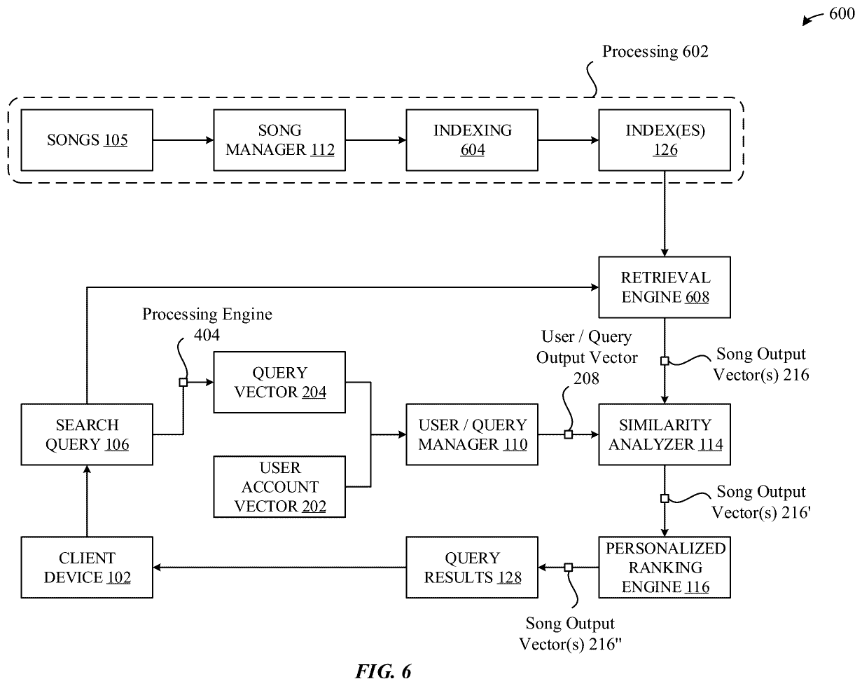

Accordingly, FIGS. 2-5 provide an understanding of how the user/query manager 110, the song manager 112, the similarity analyzer 114, and the personalized ranking engine 116 can function, interact with one another, etc., to generate query results 128 for search queries 106, according to some embodiments. A more detailed discussion of how these entities function, interact with one another, etc., is discussed below in conjunction with FIGS. 6-8.

FIG. 6 illustrates a block diagram 600 of how personalized query results 128 can be generated for a given search query 106, according to some embodiments. As shown in FIG. 6, a client computing device 102 can provide a search query 106 to the server computing device 108 (e.g., the text-based query “Creep”). In response, the server computing device 108 can identify the user account 104 that corresponds to the client computing device 102, and generate, retrieve, update, etc., the user account vector 202 that corresponds to the user account 104 (e.g., in accordance with the techniques described above in conjunction with FIGS. 2-3). Additionally, the user/query manager 110—particularly, the processing engine 404 implemented by the user/query manager 110—can generate a query vector 204 based at least in part on the search query 106 (e.g., in accordance with the techniques described above in conjunction with FIGS. 2 and 4). The user/query manager 110—particularly, the user/query encoder 206—can then generate a user/query output vector 208 based on the user account vector 202 and the query vector 204 (e.g., in accordance with the techniques described above in conjunction with FIG. 2).

As shown in FIG. 6, processing 602 can be performed by the server computing device 108 on a routine, responsive, etc., basis. According to some embodiments, processing 602 can represent any number, type, form, etc., of operations, at any level of granularity, involved in generating, retrieving, storing, etc., information about the songs 105 (e.g., as they are received to be managed by the server computing device 108). For example, the processing 602 can include the song manager 112 generating song output vectors 216 for songs 105. The processing 602 can also include performing indexing operations 604 for the songs 105, which can include establishing search-related information for effectively storing the songs 105 within one or more of the indexes 126. The search-related information can be established using any known approach, e.g., LLM models can be utilized to generate, for a given song 105, search tokens that are relevant to the song 105. In this manner, information included in search queries 106—such as text, images, audio, video, etc.—can be referenced against the indexes 126 to identify songs 105 that are relevant to the search query 106.

Accordingly, and as shown in FIG. 6, a retrieval engine 608 implemented by the server computing device 108 can be configured to receive the search query 106 and to interface with the indexes 126 to identify songs 105 that are relevant to the search query 106 (e.g., the top ten songs related to the search term “Creep”). It is noted that the retrieval engine 608 can implement any number, type, form, etc., of operations on the search query 106 prior to interfacing with the indexes 126. For example, the retrieval engine 608 can implement one or more LLMs that reorganize, supplement, etc., the search query 106 so as to increase the overall accuracy by which the search query 106 accurately maps to songs 105 managed by the indexes 126. It is noted that the songs 105 identified by the retrieval engine 608 can be ordered based on the respective strengths by which the songs 105 match the search query 106 (referred to herein as an initial ordering). In turn, the retrieval engine 608 can obtain song output vectors 216 (that are generated by way of the processing 602 and that correspond to the identified songs 105), and can provide the song output vectors 216 to the similarity analyzer 114. According to some embodiments, the retrieval engine 608 can be configured to modify, supplement, etc., the song output vectors 216 prior to providing them to the similarity analyzer 114. For example, the retrieval engine 608 can modify the song output vectors 216 to account for popularity changes in the corresponding songs 105 that have taken place since the song output vectors 216 were generated (that are not reflected in the (unmodified) song output vectors 216).

Accordingly, the similarity analyzer 114, upon receiving the user/query output vector 208 and the song output vectors 216, can begin generating, for each song output vector 216, a respective score that represents an overall similarity between the user/query output vector 208 and the song output vector 216. As described herein, the respective similarity score for a given song output vector 216 can be generated by the similarity analyzer 114 using any approach(es) for analyzing similarities between vectors, e.g., Cosine similarity operations. In this regard, and as shown in FIG. 6, the similarity analyzer 114 can output, to the personalized ranking engine 116, song output vectors 216′, which represent song output vectors 216 that have been tagged with respective similarity scores (relative to the user/query output vector 208). It is noted that information can be removed from the song output vectors 216′ (and the song output vectors 216″, described below) such that only song identifier and corresponding score information remains, thereby improving overall data transfer efficiencies.

As previously discussed herein, the personalized ranking engine 116 can be configured to filter, order, etc., the song output vectors 216′ based at least in part on their respective similarity scores, such that the corresponding songs 105 are ordered based on the user/query output vector 208—i.e., ordered from most/least relevant to both the user account 104 and the search query 106 (referred to herein as a personalized ordering). Accordingly, the initial ordering of the songs 105 (provided by the retrieval engine 608) can differ from the personalized ordering. In this regard, the personalized ordering can be beneficial in that it differs from what would ordinarily be provided by the retrieval engine 608 (absent any influence from what is known to be relevant to the user account 104 (as provided by the user/query output vector 208)).

The aforementioned personalized ordering is illustrated in FIG. 6 as song output vectors 216″. As shown in FIG. 6, the song output vectors 216″ are then provided, in the form of query results 128, by the server computing device 108 to the client computing device 102. As previously described herein, the query results 128 can include any amount of information related to the songs 105. For example, the query results 128 can include metadata information associated with the songs 105 that enables a user interface on the client computing device 102 to render affordances for the songs 105. A user of the client computing device 102 can utilize the affordances to interact with (e.g., play back, learn more information about, etc.) the songs 105. In turn, the user's interactions with the song(s) 105 can be provided to, gathered by, etc., the server computing device 108 in the form of user account 104 information that can be used to update the user account vector 202 that corresponds to the user account 104 (e.g., in accordance with the techniques described in conjunction with FIGS. 2-4).

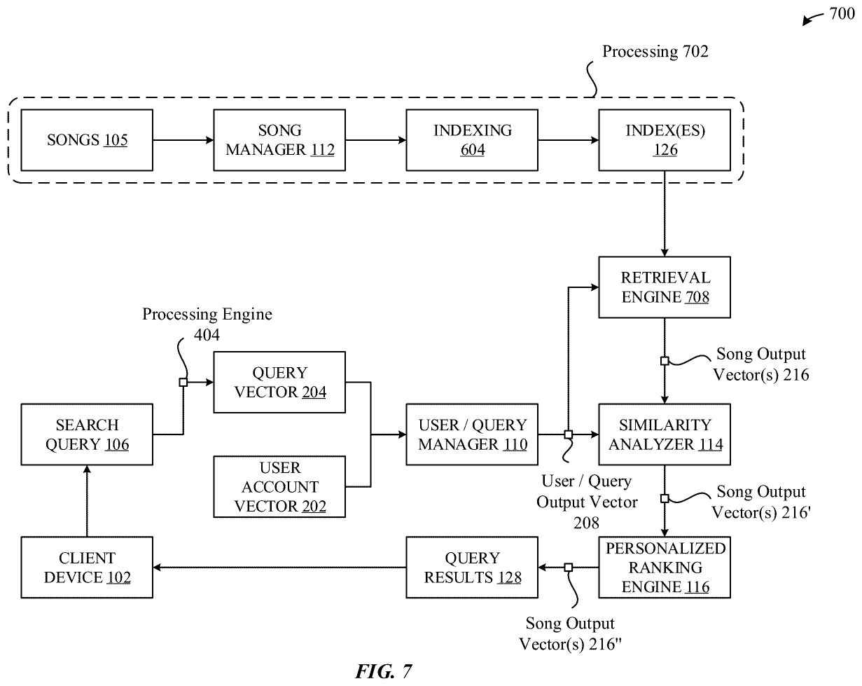

FIG. 7 illustrates a block diagram 700 of how semantic query results 128 can be generated for a given search query 106 (e.g., “relax deep house”), according to some embodiments. The architecture, flow, etc., of FIG. 7 largely resembles that of FIG. 6. However, the semantic query results 128 (generated in accordance with FIG. 7) can differ from personalized query results 128 (generated in accordance with FIG. 6) in a few different aspects. First, the processing 702 can involve utilizing approximate nearest-neighbor (ANN) indexes for storing information associated with songs 105, as such indexes can excel in enabling semantic relationships to be identified by a retrieval engine 708 using the user/query output vector 208 (where such semantic relationships may not be as identifiable, for example, using the keyword-based matching techniques employed by the retrieval engine 608 discussed above in conjunction with FIG. 6). Additionally, the output provided by the similarity analyzer 114—i.e., song output vectors 216′ that are associated with respective strengths by which the corresponding songs 105 match the search query 106—can be provided to the personalized ranking engine 116 for further reranking/filtering to produce song output vectors 216″ (e.g., in accordance with the techniques described herein). In this manner, the song output vectors 216″ can be provided to the client computing device 102 in the form of query results 128 (e.g., in accordance with the techniques described herein). It is noted, however, that the server computing device 108 can be configured to modify, supplement, etc., the song output vectors 216″ prior to providing them in the form of query results 128, consistent with the scope of this disclosure.

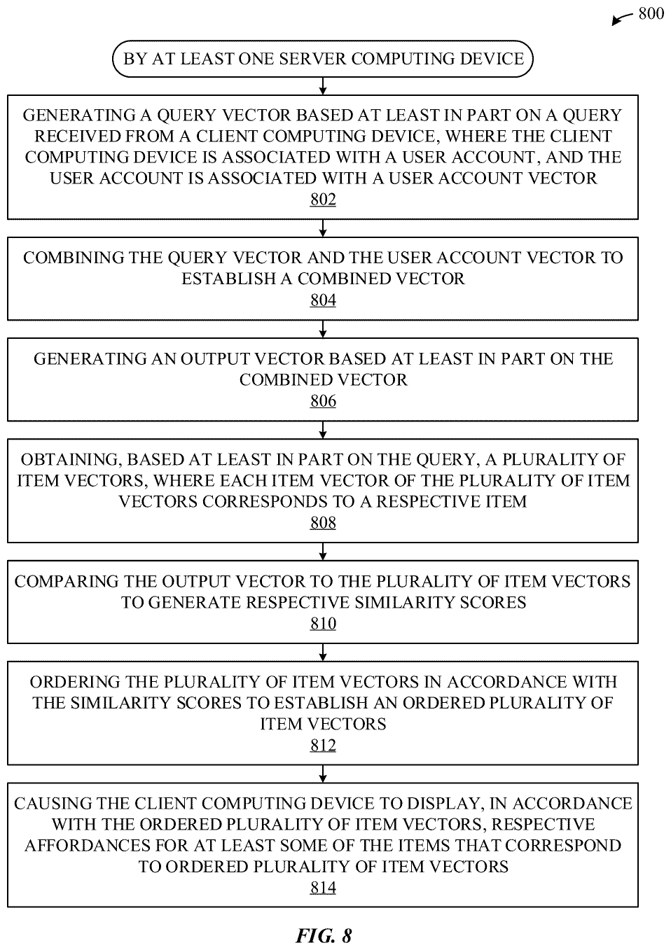

Accordingly, FIGS. 6-7 provide overview of how query results 128 can be generated for different types of search queries 106, according to some embodiments. Additionally, FIG. 8 illustrates a method 800 for providing relevant search results for search queries, according to some embodiments. As shown in FIG. 8, the method 800 begins at step 802, where the server computing device 108 generates a query vector based at least in part on a query received from a client computing device, where the client computing device is associated with a user account, and the user account is associated with a user account vector (e.g., as described above in conjunction with FIGS. 1-7). At step 804, the server computing device 108 combines the query vector and the user account vector to establish a combined vector (e.g., as also described above in conjunction with FIGS. 1-7). At step 806, the server computing device 108 generates an output vector based at least in part on the combined vector (e.g., as also described above in conjunction with FIGS. 1-7).

At step 808, the server computing device 108 obtains, based at least in part on the query, a plurality of item vectors, where each item vector of the plurality of item vectors corresponds to a respective item (e.g., as also described above in conjunction with FIGS. 1-7). At step 810, the server computing device 108 compares the output vector to the plurality of item vectors to generate respective similarity scores (e.g., as also described above in conjunction with FIGS. 1-7). At step 812, the server computing device 108 orders the plurality of item vectors in accordance with the similarity scores to establish an ordered plurality of item vectors (e.g., as also described above in conjunction with FIGS. 1-7). At step 814, the server computing device 108 causes the client computing device to display, in accordance with the ordered plurality of item vectors, respective affordances for at least some of the items that correspond to ordered plurality of item vectors (e.g., as also described above in conjunction with FIGS. 1-7).

It should be noted that the various vectors described herein can enable useful features to be implemented. For example, song output vectors 216 can be utilized to identify songs 105 that are similar to one another, which can be useful for generating personalized recommended playlists for a given user based on one or more songs 105 in which the user has exhibited an interest. In another example, the song output vectors 216 can be utilized to group songs 105 together within a given playlist associated with a user, which can be useful when the playlist is otherwise difficult to navigate due to including a large number of songs. In yet another example, the user account vectors 202 can be utilized to identify users who are similar to one another, which can be useful for establishing social connections between users, recommending complementary songs between users, and so on. In yet another example, the user account vectors 202/query vectors 204 can be utilized to identify correlations between users, their searches, and so on, which can be useful for identifying popular search queries among similar types of users. Again, these examples are not meant to be limiting.

FIG. 9 illustrates a detailed view of a computing device 900 that can be used to implement the various components described herein, according to some embodiments. In particular, the detailed view illustrates various components that can be included in the client computing device 102, the server computing device 108, the knowledge sources 118, and so on, described above in conjunction with FIG. 1.

As shown in FIG. 9, the computing device 900 can include a processor 902 that represents a microprocessor or controller for controlling the overall operation of computing device 900. The computing device 900 can also include a user input device 908 that allows a user of the computing device 900 to interact with the computing device 900. For example, the user input device 908 can take a variety of forms, such as a button, keypad, dial, touch screen, audio input interface, visual/image capture input interface, input in the form of sensor data, etc. Furthermore, the computing device 900 can include a display 910 (screen display) that can be controlled by the processor 902 to display information to the user. A data bus 916 can facilitate data transfer between at least a storage device 940, the processor 902, and a controller 913. The controller 913 can be used to interface with and control different equipment through an equipment control bus 914. The computing device 900 can also include a network/bus interface 911 that couples to a data link 912. In the case of a wireless connection, the network/bus interface 911 can include a wireless transceiver.

The computing device 900 also includes a storage device 940, which can comprise a single disk or a plurality of disks (e.g., SSDs), and includes a storage management module that manages one or more partitions within the storage device 940. In some embodiments, storage device 940 can include flash memory, semiconductor (solid state) memory or the like. The computing device 900 can also include a Random-Access Memory (RAM) 920 and a Read-Only Memory (ROM) 922. The ROM 922 can store programs, utilities, or processes to be executed in a non-volatile manner. The RAM 920 can provide volatile data storage, and stores instructions related to the operation of the computing devices described herein.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, software modules, and/or components.

Implementations within the scope of the present disclosure include a computer-readable storage medium that encodes instructions organized as an application (e.g., application 970) that, when executed by one or more processing units, control an electronic device (e.g., device 968) to perform the process of FIG. 9B, the process of FIG. 9C, and/or one or more other processes and/or processes described herein.

It should be recognized that application 970 (e.g., illustrated in FIG. 9D) can be any suitable type of application, including, for example, one or more of: a browser application, an application that functions as an execution environment for plug-ins, widgets, or other applications, a fitness application, a health application, an accessory management application, a home application, a digital payments application, a media application, a social network application, a messaging application, and/or a maps application. In some embodiments, application 970 is an application that is pre-installed on device 968 at purchase (e.g., a first party application). In some embodiments, application 970 is an application that is provided to device 968 via an operating system update file (e.g., a first party application or a second party application). In other embodiments, application 970 is an application that is provided via an application store. In some embodiments, the application store can be an application store that is pre-installed on device 968 at purchase (e.g., a first party application store). In some embodiments, the application store is a third-party application store (e.g., an application store that is provided by another application store, downloaded via a network, and/or read from a storage device).

Referring to FIG. 9B and FIG. 9F, application 970 obtains information (e.g., 960). In some embodiments, at 960, information is obtained from at least one hardware component of device 968. In some embodiments, at 960, information is obtained from at least one software module (e.g., a set of one more instructions) of device 968. In some embodiments, at 960, information is obtained from at least one hardware component external to device 968 (e.g., a peripheral device, an accessory device, and/or a server). In some embodiments, the information obtained at 960 includes positional information, time information, notification information, user information, environment information, electronic device state information, weather information, media information, historical information, event information, hardware information, and/or motion information. In some embodiments, in response to and/or after obtaining the information at 960, application 970 provides the information to system (e.g., 962).

In some embodiments, the system (e.g., 980 as illustrated in FIG. 9E) is an operating system hosted on device 968. In some embodiments, the system (e.g., 980 as illustrated in FIG. 9E) is an external device (e.g., a server, a peripheral device, an accessory, and/or a personal computing device) that includes an operating system.

Referring to FIG. 9C, application 970 obtains information (e.g., 964). In some embodiments, the information obtained at 964 includes positional information, time information, notification information, user information, environment information electronic device state information, weather information, media information, historical information, event information, hardware information and/or motion information. In response to and/or after obtaining the information at 964, application 970 performs an operation with the information (e.g., 966). In some embodiments, the operation performed at 966 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 980 based on the information.

In some embodiments, one or more steps of the process of FIG. 9B and/or the process of FIG. 9C is performed in response to a trigger. In some embodiments, the trigger includes detection of an event, a notification received from system 980, a user input, and/or a response to a call to an API provided by system 980.

In some embodiments, the instructions of application 970, when executed, control device 968 to perform the process of FIG. 9B and/or the process of FIG. 9C by calling an application programming interface (API) (e.g., API 976) provided by system 980. In some embodiments, application 970 performs at least a portion of the process of FIG. 9B and/or the process of FIG. 9C without calling API 976.

In some embodiments, one or more steps of the process of FIG. 9B and/or the process of FIG. 9C includes calling an API (e.g., API 976) using one or more parameters defined by the API. In some embodiments, the one or more parameters include a constant, a key, a data structure, an object, an object class, a variable, a data type, a pointer, an array, a list or a pointer to a function or a process, and/or another way to reference a data or other item to be passed via the API.

Referring to FIG. 9D, device 968 is illustrated. In some embodiments, device 968 is a personal computing device, a smart phone, a smart watch, a fitness tracker, a head mounted display (HMD) device, a media device, a communal device, a speaker, a television, and/or a tablet. Device 968 includes application 970 and an operating system (not shown) (e.g., system 980 as illustrated in FIG. 9E). Application 970 includes application implementation instructions 972 and API calling instructions 974. System 980 includes API 976 and implementation instructions 978. It should be recognized that device 968, application 970, and/or system 980 can include more, fewer, and/or different components than illustrated in FIGS. 9D and 9E.

In some embodiments, application implementation instructions 972 is a software module that includes a set of one or more computer-readable instructions. In some embodiments, the set of one or more computer-readable instructions correspond to one or more operations performed by application 970. For example, when application 970 is a messaging application, application implementation instructions 972 can include operations to receive and send messages. In some embodiments, application implementation instructions 972 communicates with API calling instructions to communicate with system 980 via API 976 (e.g., as illustrated in FIG. 9E).

In some embodiments, API calling instructions 974 is a software module that includes a set of one or more computer-executable instructions.

In some embodiments, implementation instructions 978 is a software module that includes a set of one or more computer-executable instructions.

In some embodiments, API 976 is a software module that includes a set of one or more computer-executable instructions. In some embodiments, API 976 provides an interface that allows a different set of instructions (e.g., API calling instructions 974) to access and/or use one or more functions, processes, procedures, data structures, classes, and/or other services provided by implementation instructions 978 of system 980. For example, API calling instructions 974 can access a feature of implementation instructions 978 through one or more API calls or invocations (e.g., embodied by a function call, a method call, or a process call) exposed by API 976 and can pass data and/or control information using one or more parameters via the API calls or invocations. In some embodiments, API 976 allows application 970 to use a service provided by a Software Development Kit (SDK) library. In some embodiments, application 970 incorporates a call to a function or process provided by the SDK library and provided by API 976 or uses data types or objects defined in the SDK library and provided by API 976. In some embodiments, API calling instructions 974 makes an API call via API 976 to access and use a feature of implementation instructions 978 that is specified by API 976. In such embodiments, implementation instructions 978 can return a value via API 976 to API calling instructions 974 in response to the API call. The value can report to application 970 the capabilities or state of a hardware component of device 968, including those related to aspects such as input capabilities and state, output capabilities and state, processing capability, power state, storage capacity and state, and/or communications capability. In some embodiments, API 976 is implemented in part by firmware, microcode, or other low level logic that executes in part on the hardware component.

In some embodiments, API 976 allows a developer of API calling instructions 974 (which can be a third-party developer) to leverage a feature provided by implementation instructions 978. In such embodiments, there can be one or more sets of API calling instructions (e.g., including API calling instructions 974) that communicate with implementation instructions 978. In some embodiments, API 976 allows multiple sets of API calling instructions written in different programming languages to communicate with implementation instructions 978 (e.g., API 976 can include features for translating calls and returns between implementation instructions 978 and API calling instructions 974) while API 976 is implemented in terms of a specific programming language. In some embodiments, API calling instructions 974 calls APIs from different providers such as a set of APIs from an OS provider, another set of APIs from a plug-in provider, and/or another set of APIs from another provider (e.g., the provider of a software library) or creator of the another set of APIs.

Examples of API 976 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 968. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 978 is a system (e.g., an operating system and/or a server system) software module (e.g., a collection of computer-readable instructions) that is constructed to perform an operation in response to receiving an API call via API 976. In some embodiments, implementation instructions 978 is constructed to provide an API response (via API 976) as a result of processing an API call. By way of example, implementation instructions 978 and API calling instructions 974 can each be any one of an operating system, a library, a device driver, an API, an application program, or other module. It should be understood that implementation instructions 978 and API calling instructions 974 can be the same or different type of software module from each other. In some embodiments, implementation instructions 978 is embodied at least in part in firmware, microcode, or other hardware logic.

In some embodiments, implementation instructions 978 returns a value through API 976 in response to an API call from API calling instructions 974. While API 976 defines the syntax and result of an API call (e.g., how to invoke the API call and what the API call does), API 976 might not reveal how implementation instructions 978 accomplishes the function specified by the API call. Various API calls are transferred via the one or more application programming interfaces between API calling instructions 974 and implementation instructions 978. Transferring the API calls can include issuing, initiating, invoking, calling, receiving, returning, and/or responding to the function calls or messages. In other words, transferring can describe actions by either of API calling instructions 974 or implementation instructions 978. In some embodiments, a function call or other invocation of API 976 sends and/or receives one or more parameters through a parameter list or other structure.

In some embodiments, implementation instructions 978 provides more than one API, each providing a different view of or with different aspects of functionality implemented by implementation instructions 978. For example, one API of implementation instructions 978 can provide a first set of functions and can be exposed to third party developers, and another API of implementation instructions 978 can be hidden (e.g., not exposed) and provide a subset of the first set of functions and also provide another set of functions, such as testing or debugging functions which are not in the first set of functions. In some embodiments, implementation instructions 978 calls one or more other components via an underlying API and thus be both an API calling instructions and an implementation instructions. It should be recognized that implementation instructions 978 can include additional functions, processes, classes, data structures, and/or other features that are not specified through API 976 and are not available to API calling instructions 974. It should also be recognized that API calling instructions 974 can be on the same system as implementation instructions 978 or can be located remotely and access implementation instructions 978 using API 976 over a network. In some embodiments, implementation instructions 978, API 976, and/or API calling instructions 974 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, process 800 (e.g., FIG. 8) is performed at a first computer system (as described herein) via a system process (e.g., an operating system process and/or a server system process) that is different from one or more applications executing and/or installed on the first computer system.

In some embodiments, process 800 (e.g., FIG. 8) is performed at a first computer system (as described herein) by an application that is different from a system process.

In some embodiments, the instructions of the application, when executed, control the first computer system to perform process 800 (e.g., FIG. 8) by calling an application programming interface (API) provided by the system process. In some embodiments, the application performs at least a portion of one or process 800 (e.g., FIG. 8) without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform one or more process 800 (e.g., FIG. 8) by calling an application programming interface (API) provided by the system process using one or more parameters.

In some embodiments, at least one API is a software module (e.g., a collection of computer-readable instructions) that provides an interface that allows a different set of instructions (e.g., API calling instructions) to access and use one or more functions, processes, procedures, data structures, classes, and/or other services provided by a set of implementation instructions of the system process. The API can define one or more parameters that are passed between the API calling instructions and the implementation instructions.

As described above, in some embodiments, an application controls a computer system to perform process 800 (e.g., FIG. 8) by calling an application programming interface (API) provided by a system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, API 976 defines a first API call that can be provided by API calling instructions 974, wherein the definition for the first API call specifies call parameters described above with respect to process 800 (e.g., FIG. 8).

In some embodiments, API 976 defines a first API call response that can be provided to an application by API calling instructions 974, wherein the first API call response includes parameters described above with respect to process 800 (e.g., FIG. 8).

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call.

In some embodiments, the set of implementation instructions is included in the device (e.g., 168) that runs the application. In some embodiments, the set of implementation instructions is included in an electronic device that is separate from the device that runs the application.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

In some embodiments, content is automatically generated by one or more computer systems in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other embodiments, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some embodiments, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

The various aspects, embodiments, implementations, or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data that can be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

As described herein, one aspect of the present technology is the gathering and use of data available from various sources to improve user experiences. The present disclosure contemplates that in some instances, this gathered data may include personal information data that uniquely identifies or can be used to contact or locate a specific person. Such personal information data can include demographics data, location-based data, telephone numbers, email addresses, home addresses, data or records relating to a user's health or level of fitness (e.g., vital signs measurements, medication information, exercise information), date of birth, smart home activity, or any other identifying or personal information. The present disclosure recognizes that the use of such personal information data, in the present technology, can be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select to provide only certain types of data that contribute to the techniques described herein. In addition to providing “opt in” and “opt out” options, the present disclosure contemplates providing notifications relating to the access or use of personal information. For instance, a user may be notified that their personal information data may be accessed and then reminded again just before personal information data is accessed.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A method for performing searches, the method comprising, by a server computing device:
generating a query vector based at least in part on a query received from a client computing device, wherein the client computing device is associated with a user account, and the user account is associated with a user account vector;
combining the query vector and the user account vector to establish a combined vector;
generating an output vector based at least in part on the combined vector;
obtaining, based at least in part on the query, a plurality of item vectors, wherein each item vector of the plurality of item vectors corresponds to a respective item;
comparing the output vector to the plurality of item vectors to generate respective similarity scores;
ordering the plurality of item vectors in accordance with the similarity scores to establish an ordered plurality of item vectors; and
causing the client computing device to display, in accordance with the ordered plurality of item vectors, respective affordances for the items that correspond to the ordered plurality of item vectors.

2. The method of claim 1, wherein the query comprises text content, image content, audio content, video content, or some combination thereof.

3. The method of claim 1, wherein the query vector is generated based at least in part on the query using a transformer-based large language model (LLM).

4. The method of claim 1, wherein the user account vector is generated based at least in part on:
a first set item vectors that correspond to Decisions marked as favorites under the user account;
a second set of item vectors that correspond to Decisions included in a library of Decisions associated with the user account;
a third set of item vectors that correspond to Decisions accessed by the user account within a first threshold period of time; and
a fourth set of query vectors that correspond to queries provided in association with the user account within a second threshold period of time.

5. The method of claim 1, wherein combining the query vector and the user account vector to establish the combined vector comprises concatenating the query vector to the user account vector, or vice-versa.

6. The method of claim 1, wherein:
the output vector is generated based at least in part on the combined vector using a transformer-based large language model (LLM), and
the transformer-based LLM implements a set of fully connected layers and a set of input normalization layers.

7. The method of claim 1, wherein a given item vector of the plurality of item vectors is generated by:
obtaining, from a transformer-based LLM, a first item vector based at least in part on metadata associated with the corresponding respective item;
obtaining, from a machine learning model, a second item vector based at least in part on data content of the corresponding respective item; and
generating the item vector based at least in part on combining the first and second item vectors.

8. The method of claim 7, wherein, when the corresponding respective item comprises an audio file:
the metadata comprises the following song properties: album, artist, title, track number, genre, year, duration, bitrate, sample rate, channels, composer, comment, copyright, encoder, language, publisher, original artist, album artist, disc number, lyrics, mood, tempo, key, ISRC (International Standard Recording Code), recording date, release date, label, BPM (beats per minute), performer, conductor, compilation, part of a set, podcast, podcast URL, podcast ID, podcast feed, episode number, episode ID, episode URL, cover art, custom tags, or some combination thereof; and
the data content comprises the following song characteristics: melody, harmony, rhythm, tempo, meter, lyrics, chorus, verse, bridge, dynamics, instrumentation, arrangement, key, harmonic progression, timbre, form, texture, style, emotion, production, hook, groove, transition, or some combination thereof.

9. A non-transitory computer readable storage medium configured to store instructions that, when executed by at least one processor included in a server computing device, cause the server computing device to carry out steps that include:
generating a query vector based at least in part on a query received from a client computing device, wherein the client computing device is associated with a user account, and the user account is associated with a user account vector;
combining the query vector and the user account vector to establish a combined vector;
generating an output vector based at least in part on the combined vector;
obtaining, based at least in part on the query, a plurality of item vectors, wherein each item vector of the plurality of item vectors corresponds to a respective item;
comparing the output vector to the plurality of item vectors to generate respective similarity scores;
ordering the plurality of item vectors in accordance with the similarity scores to establish an ordered plurality of item vectors; and
causing the client computing device to display, in accordance with the ordered plurality of item vectors, respective affordances for the items that correspond to the ordered plurality of item vectors.

10. The non-transitory computer readable storage medium of claim 9, wherein the query comprises text content, image content, audio content, video content, or some combination thereof.

11. The non-transitory computer readable storage medium of claim 9, wherein the query vector is generated based at least in part on the query using a transformer-based large language model (LLM).

12. The non-transitory computer readable storage medium of claim 9, wherein the user account vector is generated based at least in part on:
a first set item vectors that correspond to Decisions marked as favorites under the user account;
a second set of item vectors that correspond to Decisions included in a library of Decisions associated with the user account;
a third set of item vectors that correspond to Decisions accessed by the user account within a first threshold period of time; and
a fourth set of query vectors that correspond to queries provided in association with the user account within a second threshold period of time.

13. The non-transitory computer readable storage medium of claim 9, wherein combining the query vector and the user account vector to establish the combined vector comprises concatenating the query vector to the user account vector, or vice-versa.

14. The non-transitory computer readable storage medium of claim 9, wherein:
the output vector is generated based at least in part on the combined vector using a transformer-based large language model (LLM), and
the transformer-based LLM implements a set of fully connected layers and a set of input normalization layers.

15. The non-transitory computer readable storage medium of claim 9, wherein a given item vector of the plurality of item vectors is generated by:
obtaining, from a transformer-based LLM, a first item vector based at least in part on metadata associated with the corresponding respective item;
obtaining, from a machine learning model, a second item vector based at least in part on data content of the corresponding respective item; and
generating the item vector based at least in part on combining the first and second item vectors.

16. The non-transitory computer readable storage medium of claim 15, wherein, when the corresponding respective item comprises an audio file:
the metadata comprises the following song properties: album, artist, title, track number, genre, year, duration, bitrate, sample rate, channels, composer, comment, copyright, encoder, language, publisher, original artist, album artist, disc number, lyrics, mood, tempo, key, ISRC (International Standard Recording Code), recording date, release date, label, BPM (beats per minute), performer, conductor, compilation, part of a set, podcast, podcast URL, podcast ID, podcast feed, episode number, episode ID, episode URL, cover art, custom tags, or some combination thereof; and
the data content comprises the following song characteristics: melody, harmony, rhythm, tempo, meter, lyrics, chorus, verse, bridge, dynamics, instrumentation, arrangement, key, harmonic progression, timbre, form, texture, style, emotion, production, hook, groove, transition, or some combination thereof.

17. A server computing device, comprising:
at least one processor; and
at least one memory storing instructions that, when executed by the at least one processor, cause the computing device to carry out steps that include:
generating a query vector based at least in part on a query received from a client computing device, wherein the client computing device is associated with a user account, and the user account is associated with a user account vector;
combining the query vector and the user account vector to establish a combined vector;
generating an output vector based at least in part on the combined vector;
obtaining, based at least in part on the query, a plurality of item vectors, wherein each item vector of the plurality of item vectors corresponds to a respective item;
comparing the output vector to the plurality of item vectors to generate respective similarity scores;
ordering the plurality of item vectors in accordance with the similarity scores to establish an ordered plurality of item vectors; and
causing the client computing device to display, in accordance with the ordered plurality of item vectors, respective affordances for the items that correspond to the ordered plurality of item vectors.

18. The server computing device of claim 17, wherein the query comprises text content, image content, audio content, video content, or some combination thereof.

19. The server computing device of claim 17, wherein the query vector is generated based at least in part on the query using a transformer-based large language model (LLM).

20. The server computing device of claim 17, wherein the user account vector is generated based at least in part on:
a first set item vectors that correspond to Decisions marked as favorites under the user account;
a second set of item vectors that correspond to Decisions included in a library of Decisions associated with the user account;
a third set of item vectors that correspond to Decisions accessed by the user account within a first threshold period of time; and
a fourth set of query vectors that correspond to queries provided in association with the user account within a second threshold period of time.

21. The server computing device of claim 17, wherein combining the query vector and the user account vector to establish the combined vector comprises concatenating the query vector to the user account vector, or vice-versa.

22. The server computing device of claim 17, wherein:
the output vector is generated based at least in part on the combined vector using a transformer-based large language model (LLM), and
the transformer-based LLM implements a set of fully connected layers and a set of input normalization layers.

23. The server computing device of claim 17, wherein a given item vector of the plurality of item vectors is generated by:
obtaining, from a transformer-based LLM, a first item vector based at least in part on metadata associated with the corresponding respective item;
obtaining, from a machine learning model, a second item vector based at least in part on data content of the corresponding respective item; and
generating the item vector based at least in part on combining the first and second item vectors.

24. The server computing device of claim 23, wherein, when the corresponding respective item comprises an audio file:
the metadata comprises the following song properties: album, artist, title, track number, genre, year, duration, bitrate, sample rate, channels, composer, comment, copyright, encoder, language, publisher, original artist, album artist, disc number, lyrics, mood, tempo, key, ISRC (International Standard Recording Code), recording date, release date, label, BPM (beats per minute), performer, conductor, compilation, part of a set, podcast, podcast URL, podcast ID, podcast feed, episode number, episode ID, episode URL, cover art, custom tags, or some combination thereof; and
the data content comprises the following song characteristics: melody, harmony, rhythm, tempo, meter, lyrics, chorus, verse, bridge, dynamics, instrumentation, arrangement, key, harmonic progression, timbre, form, texture, style, emotion, production, hook, groove, transition, or some combination thereof.
